(19) United States
(12) Patent Application Publication
(10) Pub. No.: US 2008/0211366 A1
(43) Pub. Date: Sep. 4, 2008

(54) COMPACT MULTIFUNCTIONAL SELF-CLOSING SLIDE ASSEMBLY

(76) Inventors: Patty J. Brock, Irvine, CA (US); Claudio Reis, Ontario, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/426,696

(22) Filed: Jun. 27, 2006

Related U.S. Application Data
(60) Provisional application No. 60/694,408, filed on Jun. 27, 2005.

(51) Int. Cl. A47B 88/04; G06F 17/00

(52) U.S. Cl. 312/333; 700/302

(57) ABSTRACT

Preferred embodiments of the present slide assembly include one or more of a self-closing mechanism, a detent open/stop open mechanism and a bearing hold forward mechanism. Especially preferred embodiments include all three of these mechanisms incorporated into a slide assembly having a small cross-sectional profile. In one arrangement, the cross-sectional dimensions of the slide assembly are about 0.75 in height by about 0.59 inches in width.

### CROSS-REFERENCE TO RELATED APPLICATIONS

The present application is based on and claims the benefit of U.S. Provisional Patent Application No. 60/694,408, filed on Jun. 27, 2005, the entire contents of which are incorporated by reference and should be considered part of this specification.

### BACKGROUND OF THE INVENTION

1. Field of the Invention

The present invention relates to slide assemblies, and more particularly to compact multifunctional self-closing slide assemblies.

2. Description of the Related Art

For convenience and to conserve floor space, computer servers for high capacity computer systems are often mounted in rack structures. Typically, several computer servers are mounted in each rack structure. Each server is typically mounted on a pair of slide assemblies to allow the server to slide in and out of the rack structure for convenient access to the server. Each slide assembly comprises two or more slide segments. In slide assemblies comprising only two slide segments, a first or outer slide segment is mounted to a fame of the rack structure, and a second or inner slide segment is mounted to the server. The outer slide segment defines a channel. The inner slide segment is movable in the channel to extend or retract the slide assembly. A bearing assembly is movably positioned in the channel to facilitate sliding movement of the inner slide segment with respect to the outer slide segment.

In quick disconnect slide assemblies, the inner slide segments, which are attached to a computer server, can be entirely removed from the channel and thus detached from the outer slide segments. This allows convenient removal of the computer server from the server rack structure for repair or replacement of the computer server. The inner slide segment remains attached to the computer server when the server is removed from the rack. To replace the computer server in the server rack, the server must be mounted to the inner slide segment. However, in order to put the computer server back into the enclosure or server rack, the inner-slide segments (with the computer server attached to them) have to be reinserted to the rest of the slide assembly by guiding the inner slide segment into the outer slide segment. One disadvantage of such slide assemblies is that aligning the inner-slide segments with the outer-slide segments may be difficult, and misalignment of said segments may result in the fall of the computers server, resulting in damage to it or injury to a user.

Additionally, conventional slide assemblies may allow the inner-slide segment to be entirely withdrawn from the outer-slide segment too easily while moving the inner-slide segment out of the outer-slide, which may cause the object, such as a computer server, attached to the slides to be inadvertently withdrawn from the server rack and damaged. Also, conventional slides may have an inner-slide segment that readily slides relative to the outer-slide segment, so that the position of the server or object may drift, making it difficult to maintain the server in a fixed position, such as a fully closed position in which the inner-slide segment is fully inserted within the outer-slide segment.

Accordingly, there is a need for an improved slide assembly that avoids some of the problems discussed above.

### SUMMARY OF THE INVENTION

Accordingly, it is the principle object of the present invention to provide an improved slide assembly.

Preferred embodiments of the present slide assembly include one or more of a self-closing mechanism, a detent open/stop open mechanism and a bearing hold forward mechanism. Especially preferred embodiments include all three of these mechanisms incorporated into a slide assembly having a small cross-sectional profile. In one embodiment, the cross-sectional dimensions of the slide assembly are about 0.75 in height by about 0.59 inches in width.

In accordance with one embodiment, a slide assembly for supporting an object is provided comprising an outer slide segment and an inner slide segment. The inner slide segment is operably coupled to the outer slide segment, the inner slide segment moveable relative to the outer slide segment between a fully retracted position and a fully extended position. A self-closing mechanism is secured to the outer slide segment, the self-closing mechanism configured to engage the inner slide segment and automatically move the inner slide segment into the fully retracted position when the inner slide segment is moved to within a predetermined distance from the fully retracted position.

In accordance with another embodiment, a slide assembly for supporting an object is provided, comprising an outer slide segment and an inner slide segment. The inner slide segment is operably coupled to the outer slide segment, the inner slide segment moveable relative to the outer slide segment between a fully retracted position and a fully extended position. An intermediate slide segment interposed between the outer slide segment and the inner slide segment. A detent latch is coupled to the intermediate slide segment, the detent latch releasably coupleable to the inner slide segment to substantially lock the inner slide segment in a fully extended position relative to the intermediate slide segment and inhibit the withdrawal of the inner slide segment from the slide assembly.

In accordance with another embodiment, a slide assembly for supporting an object is provided, comprising an outer slide segment and an inner slide segment. The inner slide segment is operably coupled to the outer slide segment, the inner slide segment moveable relative to the outer slide segment between a fully retracted position and a fully extended position. An intermediate slide segment is interposed between the outer slide segment and the inner slide segment. A disconnect latch is coupled to the intermediate slide segment, the disconnect latch configured to releasably engage the inner slide segment when the inner slide segment is in a fully extended position to maintain the inner slide segment in the fully extended position and inhibit an inadvertent retraction of the inner slide segment into the intermediate slide segment.

In accordance with another embodiment, a slide assembly for supporting an object is provided, comprising an outer slide segment and an inner slide segment. The inner slide segment is operably coupled to the outer slide segment, the inner slide segment moveable relative to the outer slide segment between a fully retracted position and a fully extended position. An intermediate slide segment is interposed between the outer slide segment and the inner slide segment. A bearing assembly is releasably coupleable to the intermediate slide segment and inner slide segment to facilitate the inner slide segment to slideably move relative to the intermediate slide segment. A bearing hold-forward mechanism is configured to releasably hold the bearing assembly in a generally fixed position proximal a front end of the intermediate slide assembly upon removal of the inner slide segment from the slide assembly such that the bearing assembly can readily couple with the inner slide segment upon reinsertion of the inner slide segment.

In accordance with another embodiment, a slide assembly for supporting an object is provided, comprising an outer slide segment and an inner slide segment. The inner slide segment is operably coupled to the outer slide segment, the inner slide segment moveable relative to the outer slide segment between a fully retracted position and a fully extended position. An intermediate slide segment is interposed between the outer slide segment and the inner slide segment. An intermediate lock mechanism is releasably coupleable to the intermediate slide segment, the intermediate lock mechanism configured to automatically engage the intermediate slide segment when moved to an extended position relative to the outer slide segment to substantially lock the intermediate slide segment in the extended position and inhibit the retraction of the intermediate slide segment from said extended position.

In accordance with another embodiment, a method for operating a slide assembly comprising an inner slide segment slidably moveable relative to an outer slide segment is provided. The method comprises slidably moving the inner slide segment relative to the outer slide segment from an extended position to within a predetermined distance from a fully retracted position. The method also comprises engaging the inner slide segment with a self-closing mechanism and automatically moving the inner slide segment into the fully retracted position.

Certain objects and advantages of the invention are described herein. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of the embodiments summarized above are intended to be within the scope of the invention herein disclosed. However, despite the foregoing discussion of certain embodiments, only the appended claims (and not the present summary) are intended to define the invention. The summarized embodiments, and other embodiments of the present invention, will become readily apparent to those skilled in the art from the following detailed description of the preferred embodiments having reference to the attached figures, the invention not being limited to any particular embodiment(s) disclosed.

### BRIEF DESCRIPTION OF THE DRAWINGS

FIG. 1 is a schematic perspective view of a server management system in accordance with one of the embodiments disclosed herein.

FIG. 2A is a schematic perspective view of one embodiment of a self-closing slide assembly in a first position.

FIG. 2B is a schematic perspective view of the self-closing slide assembly of FIG. 2A in a second position.

FIG. 3 is a schematic front view of one embodiment of a self-closing mechanism.

FIG. 4 is a schematic rear view of the self-closing mechanism in FIG. 4.

FIG. 5 is a schematic perspective partial view of the self-closing mechanism of FIG. 4 mounted to a slide segment.

FIG. 6 is a schematic side view of an actuator block mounted in a slide segment.

FIG. 7 is a schematic side view of a portion of the slide assembly in FIG. 2.

FIGS. 8A-F are schematic side views of the interaction between an actuator and a self-closing mechanism in the slide assembly of FIG. 2, during opening and closing of the slide assembly.

FIG. 9A-C is a schematic side view of the operation of a reset feature of the self-closing slide assembly of FIG. 2.

FIG. 10 is a schematic side view of one embodiment of a slide segment of the slide assembly.

FIG. 11 is a schematic side view of one embodiment of a rear lock arm coupled to two adjacent slide segments.

### DETAILED DESCRIPTION OF THE PREFERRED EMBODIMENT

In the following detailed description, terms of orientation such as “top,” “bottom,” “upper,” “lower,” “front,” “frontward,” “rear,” “rearward,” and “end” are used herein to simplify the description of the context of the illustrated embodiments. Likewise, terms of sequence, such as “first” and “second,” are used to simplify the description of the illustrated embodiments. However, other orientations and sequences are possible, and the present invention should not be limited to the illustrated orientation(s). Those skilled in the art will appreciate that other orientations of the various components are possible.

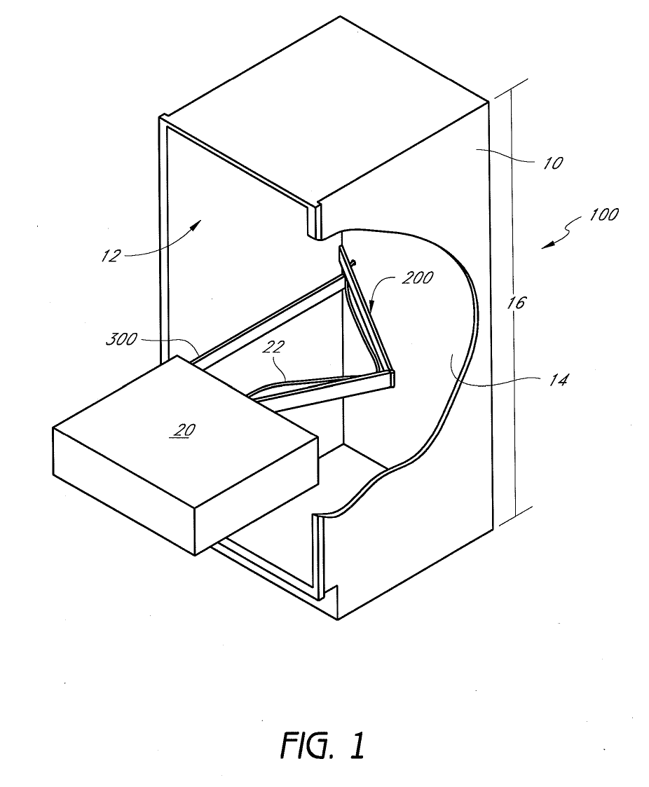

FIG. 1 illustrates one embodiment of the server management system 100. The server management system 100 preferably comprises a rack frame 10 having a front portion 12, a rear portion 14, and extending along a height 16. The server management system also comprises at least one server 20 movably mounted on the rack frame 10. In one embodiment, the server management system 100 comprises a plurality of servers 20 stacked on top of one another along the height 16 of the rack frame 10. Preferably, each of the servers 20 is movable in and out of the server rack 10 along at least one slide assembly 300. Additionally, each of the servers 20 preferably has at least one cable 22 extending from a rear portion of the server 20 toward the rear portion 14 of the rack frame 10. In a preferred embodiment, a cable management tool 200 disposed between the rear portion of the rack frame 10 and the rear portion 14 of the server 20 preferably maintains the at least one cable in an ordered configuration. Further description of the cable management tool 200 can be found in U.S. application Ser. No. 11/386,030, filed Mar. 20, 2006, the entire contents of which are hereby incorporated by reference and should be considered a part of this specification.

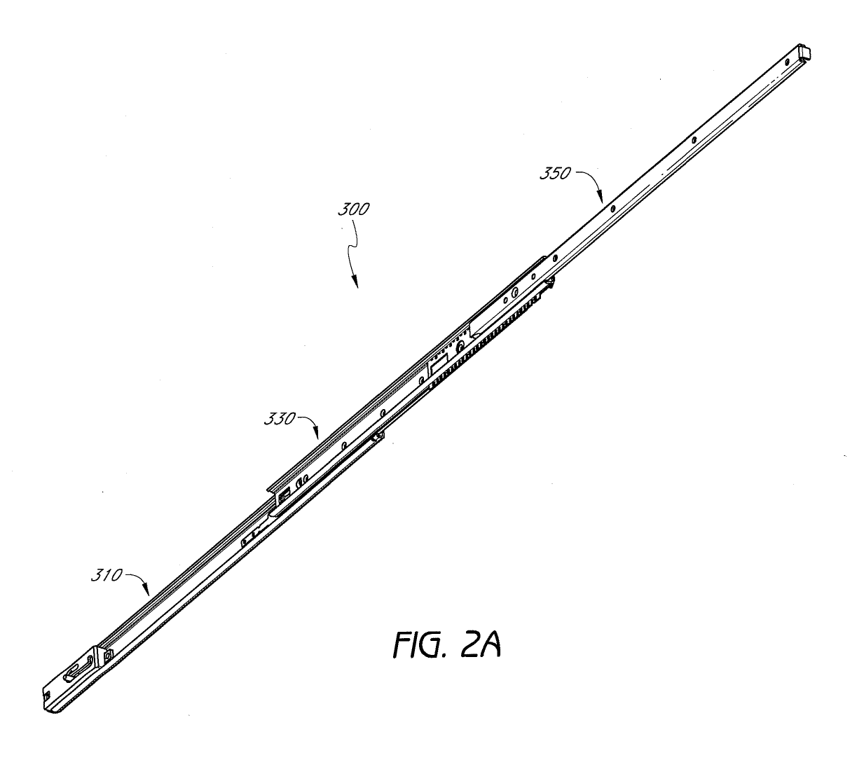

One embodiment of a slide assembly 300 is illustrated in FIGS. 2A-B. In the illustrated embodiment, the slide assembly 300 includes a first or outer slide segment 310, a second or intermediate slide segment 330, and a third or inner slide segment 350. The outer slide segment 310 is adapted for mounting to an inner surface of the rack frame or housing 10, as shown in FIG. 1. Likewise, the inner slide segment 350 is adapted for mounting to the server 20, or any other object that is to be stored in and withdrawn from the housing 10, as described above. Each computer server 20 desirably is supported in the server rack structure 10 by a pair of side assemblies 300, one on either side of the computer server 20, to allow the computer server to slide in and out of the server rack structure 10. FIG. 2A shows the slide assembly 300 in an open or fully extended position. FIG. 2B shows the slide assembly 300 in a retracted position. The slide assembly 300 can preferably be fully retracted or closed so that the inner slide segment 350 aligns over, and extends along the length of, the outer slide segment 310. In one preferred embodiment, the cross-sectional dimensions of the slide assembly 300 in a fully retracted configuration are no more than approximately 0.75 in height H and no more than approximately 0.59 inches in width W. In another embodiment, the cross-sectional dimensions of the slide assembly 300 in the fully closed or retracted position are a height H of 0.75 inches and a width W of 0.59 inches.

1. Self-Closing Mechanism

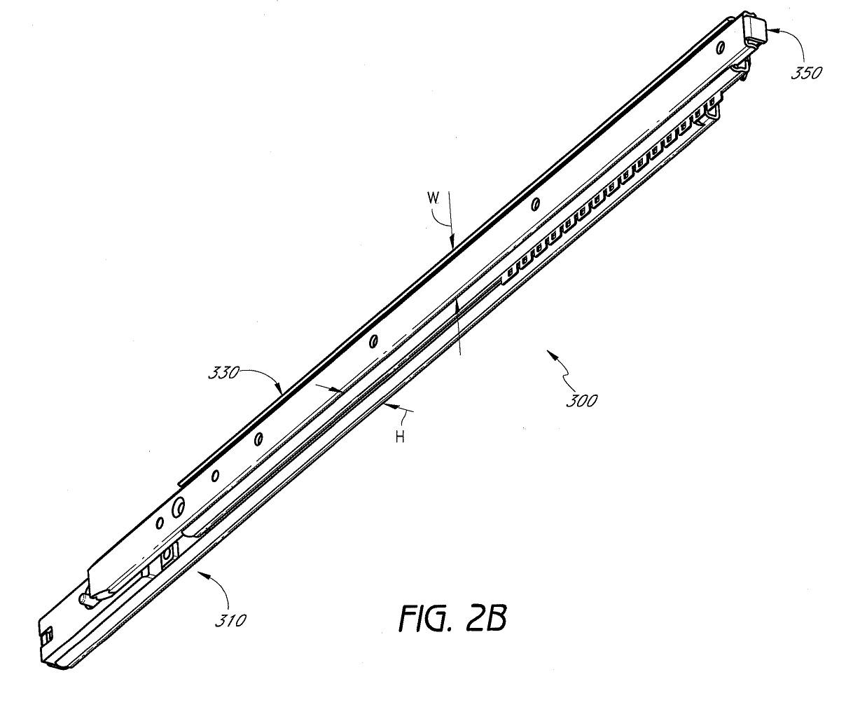

FIG. 3 is a schematic side view of the slide assembly 300, which is configured to movably support an object (e.g., a drawer or computer server) relative to a support structure (e.g., a cabinet or rack), as discussed above. In the illustrated embodiment, the slide assembly 300 includes the outer segment 310, intermediate segment 330 and inner segment 350. However, in other embodiments, the slide segment can exclude the intermediate segment 330. In still other embodiment, the slide assembly 200 can include more than one intermediate segments 330 interposed between the inner and outer segments 350, 310. The segments 310, 330, 350 preferably telescopically engage with one another, such that the slide assembly 300 can be extended and retracted. For example, the slide assembly 300 can be retracted into a fully closed position, or extended into a fully open position.

As shown in FIGS. 3-5, the slide assembly 300 includes a self-closing mechanism 400 that operates to fully close the inner slide segment 350 once the inner slide segment 350 has been moved to within a predetermined distance of the closed position. The self-closing mechanism 400 is secured to the outer segment 310. In the illustrated embodiment, the self-closing mechanism 400 is secured to the outer segment 310 via a tab 312 thereof that couples to a recess 412 in the self-closing mechanism 400. Additionally, a fastener can be inserted through a bore 414 on the self-closing mechanism 400 to fasten the same to the outer segment 310. The fastener can be, for example, a screw, bolt, pin or rivet. However, any suitable fastener can be used. In the illustrated embodiment, the bore 414 is disposed on an opposite end of the self-closing mechanism 400 from the recess 412.

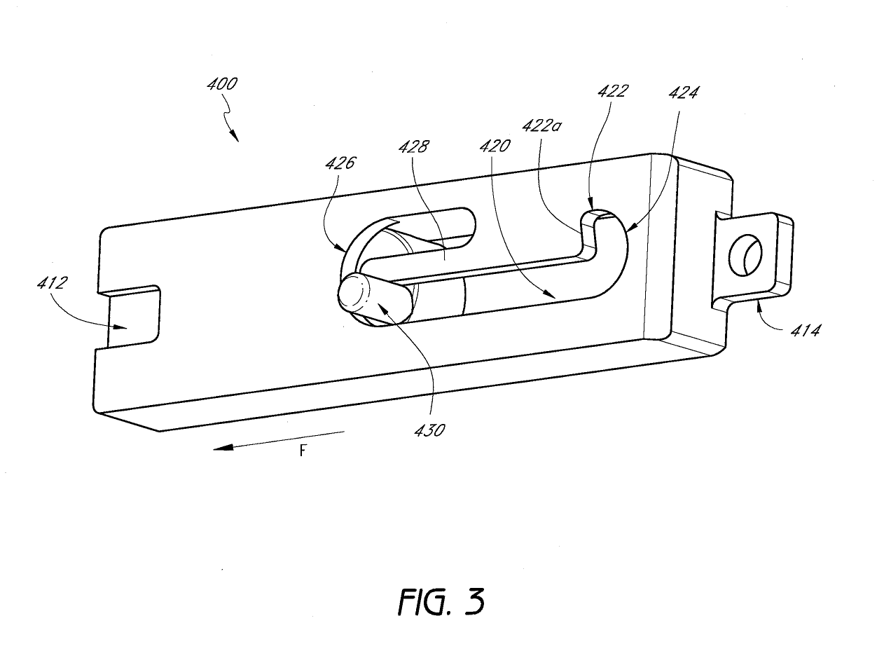

With continued reference to FIGS. 3-5, the self-closing mechanism 400 includes a slot 420 formed therein. In the illustrated embodiment, the slot 420 has a generally J-shape and extends between a hook portion 422 at a frontward portion 424 and a rearward portion 426. At least a portion of the rearward portion 426 of the J-shaped slot 420 is defined by a resilient member 428, which preferably deflects, as discussed further below. Though the slot 420 in the illustrated embodiment has a J-shape, in other embodiments the slot 420 can have other suitable shapes, such as an L-shape, U-shape, O-shape or C-shape. A pin 430 is preferably movable within the slot 420. As best shown in FIG. 4, the self-closing mechanism includes a spring 440, which applies a biasing force F to the pin 430 tending to move the pin 430 toward the rearward portion 426 of the slot 420 away from the hook portion 422 of the guide slot 420.

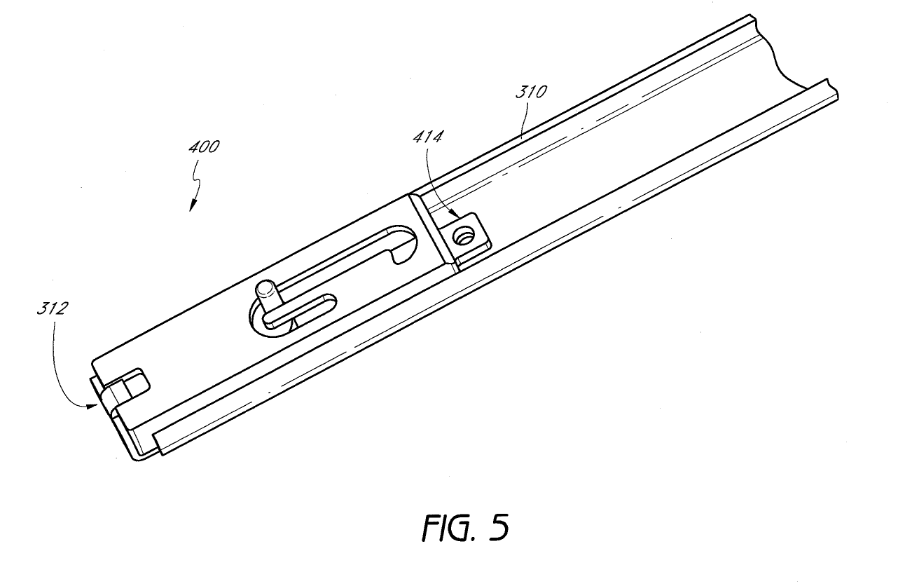

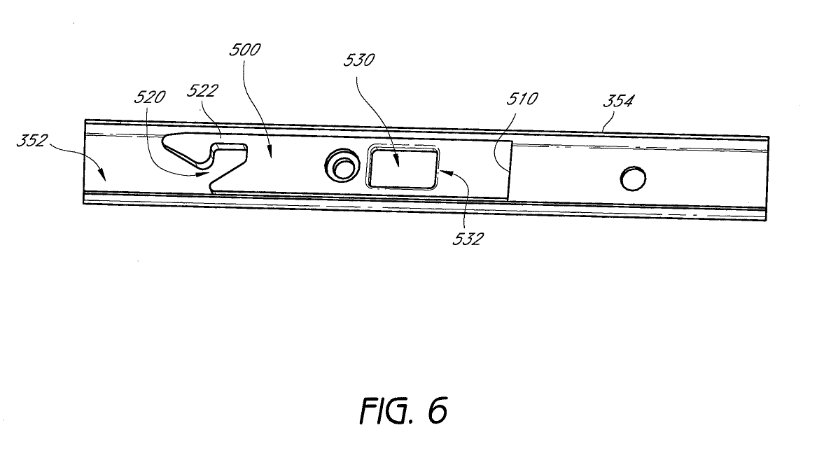

FIG. 6 illustrates an actuator 500 secured to an inner surface 352 of the inner slide segment 350. Preferably, the actuator 500 has a height such that, when secured to the inner slide segment 350, the actuator 500 does not extend above the height of the rails 354 of the inner slide segment 350. As shown in FIG. 6, the actuator 500 preferably includes a forward surface 510 at one end thereof, and a locking slot 520 at an opposite end thereof. The actuator 500 also has a recess 530 formed thereon. The surfaces that define the locking slot 520 are shaped to interact with the pin 430 when the actuator 500 is moved over the self-locking mechanism 400 as the inner-slide segment 350 is moved into a closed position C (e.g., fully retracted position) relative to the outer slide segment 310 (see FIG. 7).

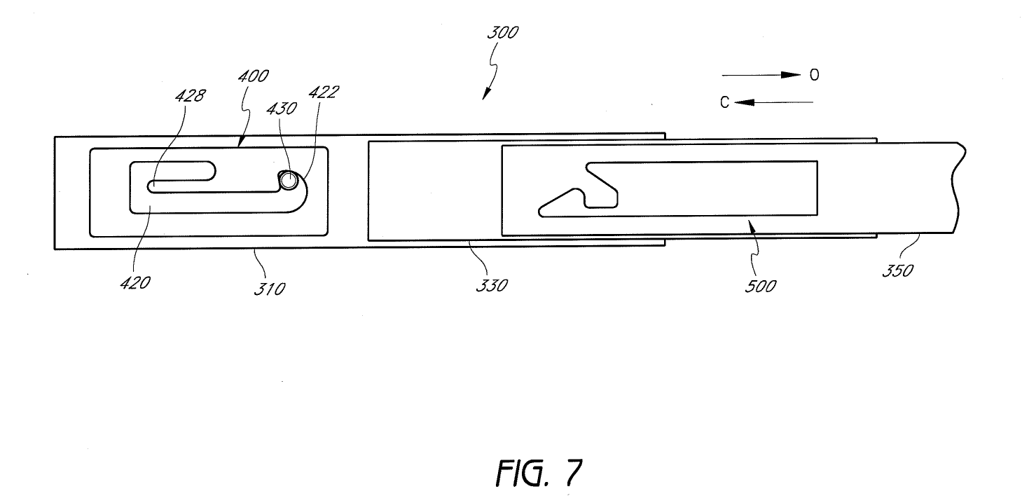

FIGS. 8A-F and 9A-C illustrate the interaction between the actuator 500 and the self-closing mechanism 400. FIGS. 8A-F show the self-closing mechanism 400 and actuator 500 in several relative positions labeled A-F. In FIG. 8A, the slide assembly 300 is in a fully retracted or closed position and the pin 430 resides within a recess 522 of the locking slot 520 of the actuator 500. As the inner slide 350 is extended (e.g., moved into an open position O, as shown in FIG. 7), the actuator 500 moves the pin 430 within the slot 420 until it reaches the hook portion 422 of the slot 420 (See FIG. 8B). The hook portion 422 has a curved surface 422a that urges the pin 430 in an upward direction, out of the recess 522 of the actuator 500, until the pin 430 abuts an angled retention surface 422b. In FIG. 8C, the combination of the biasing spring 440 and angled retention surface 422b retain the pin 430 in the illustrated “set” position, wherein the spring 440 is in tension (e.g., a stretched state).

The pin 430 preferably remains in the “set” position until the inner slide segment 350 is retracted enough relative to the outer slide segment 310 such that the actuator 500 contacts the pin 430, a shown in FIG. 8D. An upper (e.g., rearward-canted) angled surface 524 of the actuator 500 urges the pin 430 from its “set” position into the recess 522 of the locking slot 520 of the actuator 500, as shown in FIG. 8E. The biasing force F of the spring 440, which acts on the pin 430, draws the actuator 500 (and the inner slide segment 350) toward the rearward portion 426 of the slot 420 preferably until the inner slide segment 350 is fully retracted relative to the outer slide segment 310 (See FIG. 8F).

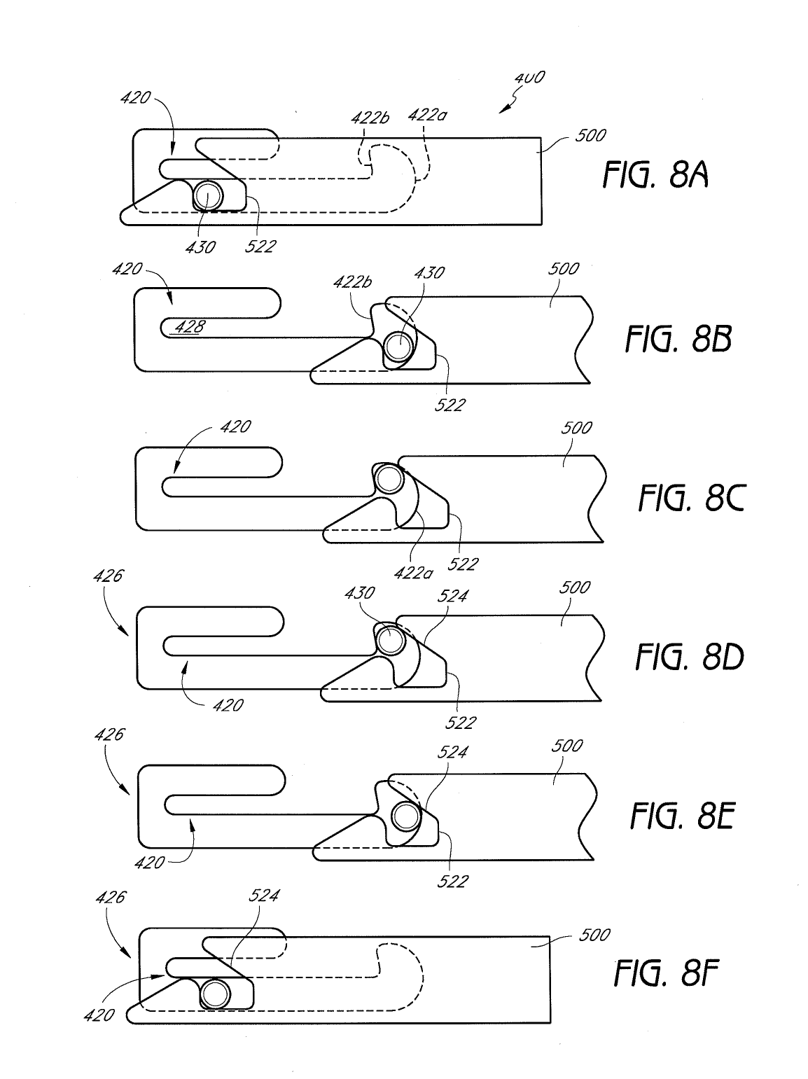

With reference to FIGS. 9A-C, the self-closing mechanism 400 also includes a reset feature. In some circumstances, the pin 430 may be displaced from its “set” position while the inner slide segment 350 is at least partially extended outside the outer slide segment 310, as shown in FIG. 9A. For example, the pin 430 may be disposed in the slot 420 proximal the rearward portion 426 thereof. The reset feature permits the pin 430 to be repositioned within the recess 522 of the actuator 500 upon manual closure of the inner segment 350. A lower (e.g., forward-canted) angled surface 526 of the actuator 500 preferably urges the pin 430 upwardly as the inner slide segment 350 is retracted into a fully closed position relative to the outer slide segment 310. Upward movement of the pin 430 is preferably accommodated by the resilient member 428 of the self-closing mechanism 400, which deflects as the pin 430 is urged upward, as shown in FIG. 9B. Once the inner slide segment 350 is retracted a sufficient distance, the pin 430 is urged into registration with the recess 522 of the actuator 500 at least in part by the biasing force of the deflected resilient member 428, as shown in FIG. 9C. The biasing force F of the spring 440 will thus maintain the inner slide segment 350 in the fully retracted position, as described above with reference to FIG. 8A, until the inner slide segment 350 is extended relative to the outer slide segment 310, as described above with reference to FIGS. 8B and 8C.

2. Detent Open/Stop Open Mechanism

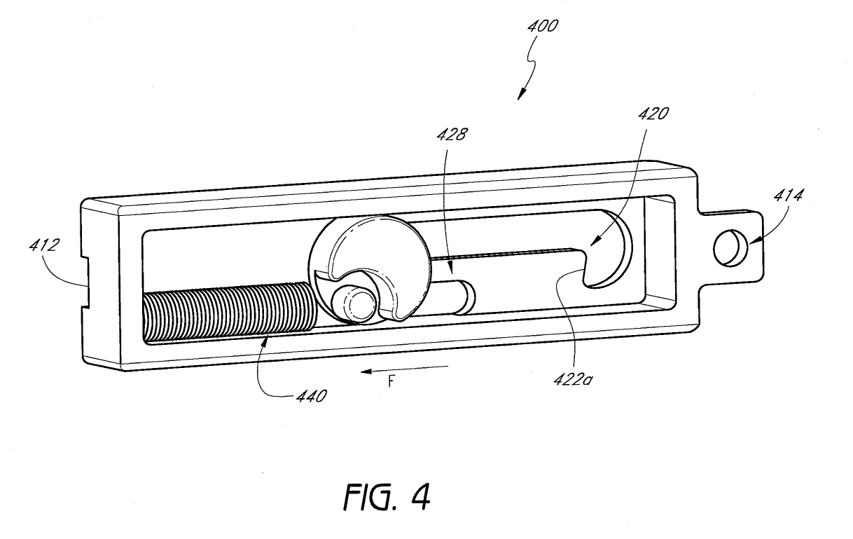

The slide assembly 300 also includes a mechanism 600 that preferably 1) provides a detent force when the inner slide segment 350 is fully extended to resist closure of the slide assembly 300 (e.g., open function), and 2) stops the inner slide segment 350 in its fully extended position to inhibit unintentional removal of the inner slide segment 350 from sliding engagement with the intermediate slide segment 330 (e.g., stop open function). These features are described with reference to FIGS. 5, 6 and 10.

The mechanism 600 preferably holds the inner slide segment 350 in an extended position and inhibits unintentional closure of the slide assembly 300. The illustrated slide assembly 300 is especially useful in mounting a computer keyboard and mouse shelf. However, the slide assembly 300 can be suitably incorporated in other arrangements. The mechanism 600 inhibits closure of the slide assembly 300 in response to forces that occur during use of the keyboard and mouse, but permits deliberate closure of the slide assembly 300.

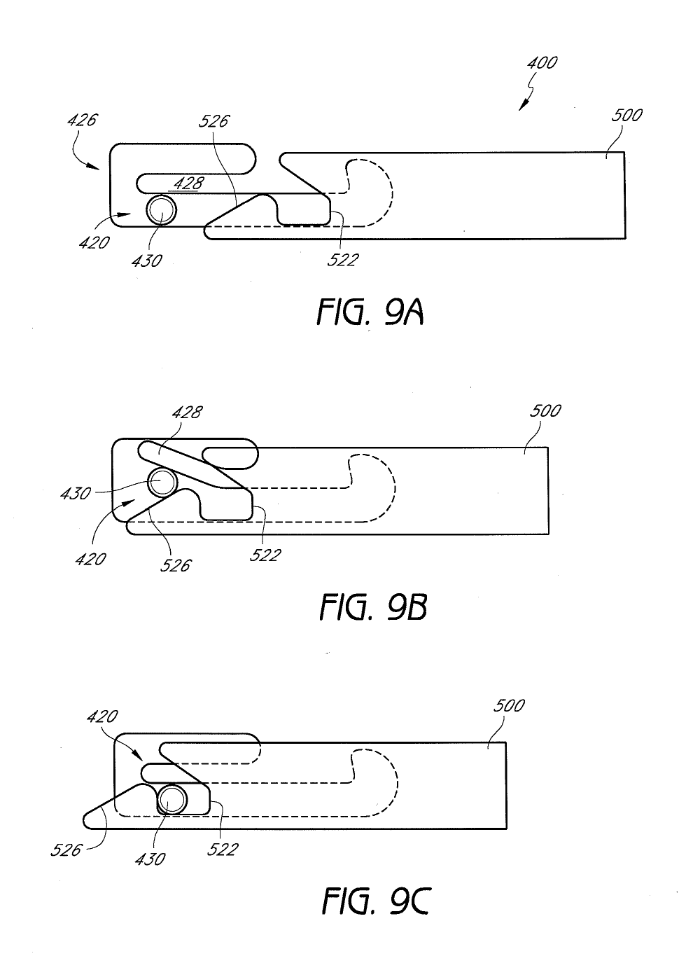

As discussed above, the inner slide segment 350 includes the actuator 500 secured thereto. As shown in FIG. 6, the recess 530 formed on the actuator 500 is generally rectangular. However, the recess 530 can have other suitable shapes. The recess 530 preferably interacts with a detent latch 610 of the mechanism 600 (See FIG. 10), which is disposed on an inner surface 332 of the intermediate slide segment 330 that faces the inner surface 352 of the inner slide segment 350. When the inner slide segment 350 is fully extended with respect to the intermediate slide segment 330, the detent latch 610 registers with the recess 530 of the actuator 500. In the illustrated embodiment, the detent latch 610 is generally rainbow-like in shape and biased toward the actuator 500, such that at least an apex 612 of the detent latch 610 is positioned within the recess 530 of the actuator 500 when the mechanism 600 and the actuator 500 are coupled to each other. However, the detent latch 610 can have other suitable configurations. The interaction of the detent latch 610 and recess 530 preferably create a detent force that substantially resists the inadvertent closure of the inner slide segment 350 relative to the intermediate slide segment 330, but the detent force may preferably be overcome by a deliberate closure force applied to the inner slide segment 550. The detent latch 610 may include a vertically-extending surface feature, or ridge 614, which contacts an edge 532 of the recess 530, so as to enhance the detent force, or closure resistance force, of the mechanism 600.

The stop open function of the mechanism 600 establishes the fully extended position of the inner slide segment 350 relative to the intermediate slide segment 330 and inhibits the unintentional removal of the inner slide segment 350 from sliding engagement with the intermediate slide segment 330. The mechanism 600 includes a disconnect latch 630, which includes a pair of spaced-apart tabs 632 extending into a channel 334 of the intermediate slide segment 330 defined between the inner surface 332 and a pair of rails 336. Rearward-facing surfaces 634 of the tabs 632 contact the forward end surface 510 of the actuator 500 to stop the inner slide segment 350 in a fully extended position (e.g., inhibit the withdrawal of the inner slide segment 350 from sliding engagement with the intermediate slide segment 330). In the illustrated embodiment, the rearward-facing surfaces 634 are generally vertical. However, in other embodiments, the surfaces 634 can have other suitable configurations. The latch 630 may be selectively biased out of the channel 334 in a direction W1 (e.g., release position), as shown in FIG. 10, to allow the actuator 500 to pass thereby, thus permitting the removal of the inner slide segment 350 from the intermediate slide segment 330. For example, the illustrated disconnect latch 630 includes a finger tab 636, which can be operated by a user to manually bias the latch 630 to the release position.

The disconnect latch 630 is also configured such that the inner slide segment 350 can be reinserted into sliding engagement with the intermediate slide segment 330 without requiring release of the disconnect latch 630. Forward-facing surfaces 638 of the tabs 632 are preferably inclined so that the actuator 500 can pass over the disconnect latch 630 when the inner slide segment 350 is reinserted into the intermediate slide segment 330.

3. Bearing Assembly Hold-Forward Mechanism

With continued reference to FIG. 10, the slide assembly 300 preferably also includes a bearing hold-forward mechanism 700, which advantageously secures a bearing assembly 710 in a position near a forward end 338 of the intermediate slide segment 330 upon removal of the inner slide segment 350. Therefore, the bearing assembly 700 is in a desired position to receive the inner slide segment 350 upon reinsertion of the same into sliding engagement with the intermediate slide segment 330. In the illustrated embodiment, the detent latch 610 substantially holds the bearing assembly 700 in the desired forward position. As shown in FIG. 10, a forward end surface 616 of the detent latch 610 abuts a bearing retainer 712 (and, specifically, in the illustrated arrangement, abuts a surface 714a of a cut-out 714 in the bearing retainer 712) to secure the bearing assembly 700 in the forward position. Upon reinsertion of the inner slide segment 350, the detent latch 610 is biased toward the web of the intermediate slide segment 330 (e.g., out of the channel 334 of the intermediate slide segment 330 and in a direction generally perpendicular to a longitudinal axis thereof) to release the bearing assembly 700. In one embodiment, the actuator 500 biases the detent latch 310 out of contact with the bearing retainer 712. Desirably, the bearing hold-forward mechanism 700 provides a positive latch force. That is, the detent latch 610 retains the bearing retainer 712 in the forward position in response to rearward force placed on the bearing retainer 712 until the detent latch 610 is released, preferably by the inner slide segment 350.

The detent latch 610 also preferably includes a lead-in guide 618 to facilitate proper alignment of the inner slide segment 350 with the bearing assembly 710 upon reinsertion of the inner slide segment 350. In the illustrated embodiment, the lead-in guide 618 defines a longitudinal slot into which the rails 354 of the inner slide segment 350 can extend. In one embodiment, the mechanism 600 is a unitary detent latch assembly that includes the lead-in guide 618, detent latch 610 and disconnect latch 630, which may be manufactured of an appropriate material via any suitable process, such as plastic injection-molding, for example. The unitary detent latch assembly 600 preferably snaps into place within the channel 334 of the intermediate slide segment 330, such that no tools or fasteners are required for assembly. In another embodiment, the unitary detent latch assembly 600 can attach to the front surface 332 or rear surface (not shown) of the intermediate slide segment 330. The multiple functions of the detent latch assembly 600 allows for fewer total parts to achieve the desired functionality of the slide assembly 300 and permits a reduction in the cross-sectional dimensions of the slide assembly 300.

4. Intermediate Lock Mechanism

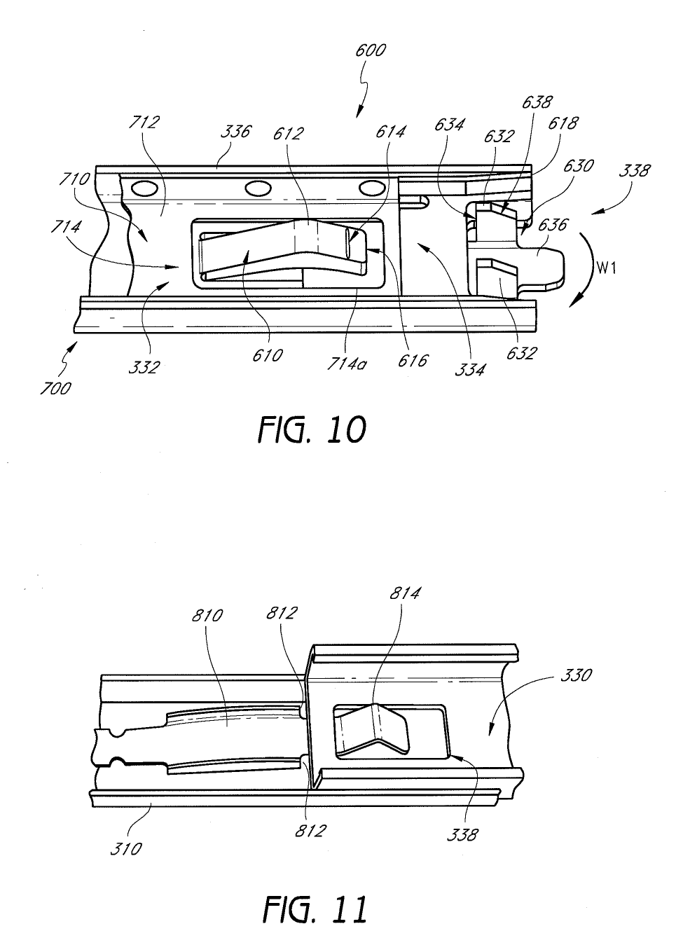

With reference to FIG. 11, the slide assembly 300 also preferably includes an intermediate lock mechanism 800 that secures the intermediate slide segment 330 in an extended position (e.g., fully open position) relative to the outer slide segment 310. Desirably, the lock mechanism 800 engages automatically when the intermediate slide segment 330 is substantially fully extended relative to the outer slide segment 310 and is released by the reinsertion and retraction of the inner slide segment 350 into the intermediate slide segment 330.

The lock mechanism 800 includes a rear lock arm 810 that secures the intermediate slide segment 330 in an extended position (e.g., fully open position) relative to the outer slide segment 310. The lock arm 810 is preferably resiliently-biased and secured to the outer slide segment 310. The lock arm 810 moves away from the web of the outer slide segment 310 once the intermediate slide segment 330 passes over the lock arm 810, such that an engagement surface 812 of the lock arm 810 contacts the intermediate slide segment 330 to inhibit the retraction thereof.

The lock arm 810 also includes a release tab 814 that can be actuated to bias the lock arm 810 toward the web of the outer slide segment 310 to release the intermediate slide segment 330. In a preferred arrangement, the tab 814 is contacted by the inner slide segment 350 and, more specifically, by the actuator 500 when the inner slide segment 350 is retracted over the intermediate slide segment 330, causing the tab 814 to withdraw from an opening 338 in the intermediate slide segment 330. The tab 814 may also be depressed by hand, or by another member or mechanism of the slide assembly 300, to permit the intermediate slide segment 330 to be retracted even if the inner slide segment 350 is not reinserted into the slide assembly 300.

5. Multi-Functionality of Components

The slide assembly 300 shown in FIG. 2 preferably incorporates the above-described mechanism 600, as well as the bearing hold forward mechanism 700 and intermediate lock mechanism 800, into a small cross-sectional envelope. Advantageously, one factor that permits such a large amount of functionality to be provided in such a small slide assembly 300 is the multi-functionality of certain individual components of the slide.

For example, the actuator 500 advantageously participates in both the self-closing feature and detent open/stop open features of the slide assembly 300, as described above. In addition, preferably, the actuator 500 operates to release the bearing hold forward mechanism 700 (e.g., to push down the detent latch 610) and intermediate lock arm 810.

The mechanism 600 or detent latch assembly, which includes the detent latch 610 and the disconnect latch 630 also advantageously performs multiple functions. As described above, the detent latch 610 interacts with the actuator 500 to create the detent open force. The detent latch 610 also holds the bearing assembly 710 in a forward position when the inner slide segment 350 is removed from the intermediate slide segment 330 so that the bearing assembly 710 is properly positioned for reinsertion of the inner slide segment 350. The detent latch 610 also includes a lead-in guide 618 to facilitate proper alignment of the inner slide segment 350 with the bearing assembly 710 upon reinsertion of the inner slide segment 350. As discussed above, in one embodiment the detent latch assembly 600 can be a unitary component that includes the detent latch 610, disconnect latch 630 and lead-in guide 618, or a combination thereof, and which can be removably secured to the intermediate slide segment 330. Accordingly, one component can advantageously perform multiple functions and the number of individual parts can be reduced leading to reduction in cost and manufacturing efficiency.

Although this invention has been disclosed in the context of a certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combine with or substituted for one another in order to form varying modes of the disclosed invention. Thus, it is intended that the scope of the present invention herein disclosed should not be limited by the particular disclosed embodiments described above, but should be determined only by a fair reading of the claims.

What is claimed is:

1. A slide assembly for supporting an object comprising:
an outer slide segment;
an inner slide segment operably coupled to the outer slide segment, the inner slide segment moveable relative to the outer slide segment between a fully retracted position and a fully extended position; and
a self-closing mechanism secured to the outer slide segment, the self-closing mechanism configured to engage the inner slide segment and automatically move the inner slide segment into the fully retracted position when the inner slide segment is moved to within a predetermined distance from the fully retracted position.

2. The slide assembly of claim 1, further comprising an actuator secured to the inner slide segment, the actuator configured to engage the self-closing mechanism when the inner slide segment is moved to within the predetermined distance to automatically retract the inner slide segment into the fully retracted position.

3. The slide assembly of claim 1, wherein the self-closing mechanism includes a spring-biased pin configured to move within a slot, the pin moveable between a substantially locked position when the inner slide segment is in an extended position and a substantially unlocked position when the inner slide segment is moved to the fully retracted position.

4. The slide assembly of claim 3, wherein the self-closing mechanism further comprises a resilient member adjacent the slot.

5. The slide assembly of claim 1, further comprising an intermediate slide segment interposed between the outer slide segment and the inner slide segment.

6. The slide assembly of claim 5, further comprising a detent latch coupled to the intermediate slide segment, the detent latch releasably coupleable to the inner slide segment to substantially lock the inner slide segment in a fully extended position relative to the intermediate slide segment and inhibit the withdrawal of the inner slide segment from the slide assembly.

7. The slide assembly of claim 6, wherein the detent latch is releasably coupleable to a recess formed in an actuator secured to the inner slide segment.

8. The slide assembly of claim 6, wherein the detent latch is decoupleable from the inner slide segment upon the application of a force to allow the withdrawal of the inner slide segment from the slide assembly.

9. The slide assembly of claim 5, further comprising a disconnect latch coupled to the intermediate slide segment, the disconnect latch configured to releasably engage the inner slide segment when the inner slide segment is in a fully extended position to maintain the inner slide segment in the fully extended position and inhibit an inadvertent retraction of the inner slide segment into the intermediate slide segment.

10. The slide assembly of claim 9, wherein the disconnect latch is moveable into a release position to allow the retraction of the inner slide segment relative to the intermediate slide segment.

11. The slide assembly of claim 5, further comprising:
a bearing assembly releasably coupleable to the intermediate slide segment and inner slide segment to facilitate the inner slide segment to slideably move relative to the intermediate slide segment; and
a bearing hold-forward mechanism configured to releasably hold the bearing assembly in a generally fixed position proximal a front end of the intermediate slide assembly upon removal of the inner slide segment from the slide assembly such that the bearing assembly can readily couple with the inner slide segment upon reinsertion of the inner slide segment.

12. The slide assembly of claim 11, wherein the bearing hold-forward mechanism comprises a forward surface of a detent latch releasably coupleable to a surface of a bearing retainer cutout of the bearing assembly to hold the bearing assembly in the generally fixed position.

13. The slide assembly of claim 11, further comprising a lead-in guide coupled to the intermediate slide segment to facilitate the alignment and reinsertion of the inner slide segment.

14. The slide assembly of claim 5, further comprising an intermediate lock mechanism releasably coupleable to the intermediate slide segment, the intermediate lock mechanism configured to automatically engage the intermediate slide segment when moved to an extended position relative to the outer slide segment to substantially lock the intermediate slide segment in the extended position and inhibit the retraction of the intermediate slide segment from said extended position.

15. The slide assembly of claim 14, wherein the intermediate lock mechanism comprises a resiliently-biased lock arm coupled to the outer slide segment, the lock arm releasably engageable to the intermediate slide segment to substantially lock the intermediate slide segment in the extended position, the lock arm having a release tab that is actuatable to bias the lock arm so as to allow the intermediate slide segment to slidably move relative to the outer slide segment.

16. The slide assembly of claim 1, wherein the slide assembly, when in the fully retracted position, has a cross-sectional width of no more than approximately 0.59 inches and a cross-sectional height of no more than approximately 0.75 inches.

17. A slide assembly for supporting an object comprising:
an outer slide segment;
an inner slide segment operably coupled to the outer slide segment, the inner slide segment moveable relative to the outer slide segment between a fully retracted position and a fully extended position;
an intermediate slide segment interposed between the outer slide segment and the inner slide segment; and
a detent latch coupled to the intermediate slide segment, the detent latch releasably coupleable to the inner slide segment to substantially lock the inner slide segment in a filly extended position relative to the intermediate slide segment and inhibit the withdrawal of the inner slide segment from the slide assembly.

18. The slide assembly of claim 17, further comprising a self-closing mechanism secured to the outer slide segment, the self-closing mechanism configured to engage the inner slide segment and automatically move the inner slide segment into the fully retracted position when the inner slide segment is moved to within a predetermined distance from the fully retracted position.

19. The slide assembly of claim 17, wherein the detent latch is decoupleable from the inner slide segment upon the application of a force to allow the withdrawal of the inner slide segment from the slide assembly.

20. A slide assembly for supporting an object comprising:
an outer slide segment;
an inner slide segment operably coupled to the outer slide segment, the inner slide segment moveable relative to the outer slide segment between a fully retracted position and a fully extended position;
an intermediate slide segment interposed between the outer slide segment and the inner slide segment; and
a disconnect latch coupled to the intermediate slide segment, the disconnect latch configured to releasably engage the inner slide segment when the inner slide segment is in a fully extended position to maintain the inner slide segment in the fully extended position and inhibit an inadvertent retraction of the inner slide segment into the intermediate slide segment.

21. The slide assembly of claim 20, further comprising a self-closing mechanism secured to the outer slide segment, the self-closing mechanism configured to engage the inner slide segment and automatically move the inner slide segment into the fully retracted position when the inner slide segment is moved to within a predetermined distance from the fully retracted position.

22. The slide assembly of claim 20, wherein the disconnect latch is moveable into a release position to allow the retraction of the inner slide segment relative to the intermediate slide segment.

23. A slide assembly for supporting an object comprising:
an outer slide segment;
an inner slide segment operably coupled to the outer slide segment, the inner slide segment moveable relative to the outer slide segment between a fully retracted position and a fully extended position;
an intermediate slide segment interposed between the outer slide segment and the inner slide segment;
a bearing assembly releasably coupleable to the intermediate slide segment and inner slide segment to facilitate the inner slide segment to slideably move relative to the intermediate slide segment; and
a bearing hold-forward mechanism configured to releasably hold the bearing assembly in a generally fixed position proximal a front end of the intermediate slide assembly upon removal of the inner slide segment from the slide assembly such that the bearing assembly can readily couple with the inner slide segment upon reinsertion of the inner slide segment.

24. The slide assembly of claim 23, further comprising a self-closing mechanism secured to the outer slide segment, the self-closing mechanism configured to engage the inner slide segment and automatically move the inner slide segment into the fully retracted position when the inner slide segment is moved to within a predetermined distance from the fully retracted position.

25. The slide assembly of claim 23, wherein the bearing hold-forward mechanism comprises a forward surface of a detent latch releasably coupleable to a surface of a bearing retainer cutout of the bearing assembly to hold the bearing assembly in the generally fixed position.

26. A slide assembly for supporting an object comprising:
an outer slide segment;
an inner slide segment operably coupled to the outer slide segment, the inner slide segment moveable relative to the outer slide segment between a fully retracted position and a fully extended position;
an intermediate slide segment interposed between the outer slide segment and the inner slide segment; and
an intermediate lock mechanism releasably coupleable to the intermediate slide segment, the intermediate lock mechanism configured to automatically engage the intermediate slide segment when moved to an extended position relative to the outer slide segment to substantially lock the intermediate slide segment in the extended position and inhibit the retraction of the intermediate slide segment from said extended position.

27. The slide assembly of claim 26, further comprising a self-closing mechanism secured to the outer slide segment, the self-closing mechanism configured to engage the inner slide segment and automatically move the inner slide segment into the fully retracted position when the inner slide segment is moved to within a predetermined distance from the fully retracted position.

28. The slide assembly of claim 26, wherein the intermediate lock mechanism comprises a resiliently-biased lock arm coupled to the outer slide segment, the lock arm releasably engageable to the intermediate slide segment to substantially lock the intermediate slide segment in the extended position, the lock arm having a release tab that is actuatable to bias the lock arm so as to allow the intermediate slide segment to slidably move relative to the outer slide segment.

29. A method for operating a slide assembly comprising an inner slide segment slidably moveable relative to an outer slide segment, comprising:
slidably moving the inner slide segment relative to the outer slide segment from an extended position to within a predetermined distance from a fully retracted position;
engaging the inner slide segment with a self-closing mechanism; and
automatically moving the inner slide segment into the fully retracted position.
